(19) United States
(12) Patent Application Publication
(10) Pub. No.: US 2005/0208676 A1
(43) Pub. Date: Sep. 22, 2005

(54) Device for aspirating, manipulating, mixing and dispensing nano-volumes of liquids

(76) Inventor: Espir Kahatt, Carlsbad, CA (US)

Correspondence Address: David B. Waller;Suite 214, 5677 Oberlin Drive, San Diego, CA, 92121, US

(21) Appl. No.: 11/082,462

(22) Filed: Mar. 17, 2005

Related U.S. Application Data
(60) Provisional application No. 60/554,761, filed on Mar. 19, 2004.

(51) Int. Cl. B01L 3/02

(52) U.S. Cl. 436/180; 422/100

(57) ABSTRACT

A pipettor device and pipette tip for aspirating, mixing, manipulating and dispensing nano-volumes of fluid comprising a directed gas flow along the exterior tip surface to assist in dispensing the liquid.

### REFERENCE TO RELATED APPLICATIONS

This application is a continuation application of provisional patent application Ser. no.: 60/554,761 filed 19 Mar. 2004.

### TECHNICAL FIELD

The present invention relates to devices for aspirating, mixing, manipulating and dispensing small volumes of liquid and pipette tips used with aspirating/dispensing devices for delivering nano-volumes of liquid.

### BACKGROUND OF THE INVENTION

All currently available pipettors aspirate and deliver liquids through a pipette tip that is essentially passive in nature. Thus, the pipette tip serves largely as a fluid reservoir, while the impetus for moving the liquid is supplied by mechanisms within the pipettor's body. This makes the pipette tip a dead space in the liquid transfer pathway, which lowers the accuracy and precision with which fluids can be aspirated and delivered and raises the minimum volume that can be reliably transferred. Largely because of the problems created by this dead space, no one has yet developed a hand-held pipettor capable of accurately transferring nanoliter volumes.

Consequently there is a need in the industry for such a pipettor in the area of manually run assays that would provide distributed access to nanoliter pipetting where space and capital resources are limited. These areas include rapid assay development and configuration prior to production high-throughput screening (most automated drug discovery screens are adapted from manual assays), secondary evaluations of drug hits and leads, chemical syntheses, diagnostic tests, and basic research investigations in areas such as genomics and proteomics. The availability of a hand-held pipettor capable of delivering precise, nanoliter volumes would eliminate the need for time-consuming dilution steps, reduce the waste of valuable reagents, and increase accuracy in these assays. It would further provide access to nanoliter pipetting for fully automated robotic systems or workstation platforms.

### SUMMARY OF THE INVENTION

The present invention provides a pipette tip for a pipetting device comprising an elongated body having a front portion, a pipettor interface portion, an upper surface and a lower surface; a plurality of reservoirs positioned at the interface portion, the reservoirs having a plurality of flexible membranes covering the reservoirs along the upper surface or the upper and lower surfaces; a fluidic channel through the elongated body connecting said plurality of reservoirs; an aligning means on the pipettor interface portion to position the tip in the pipetting device; and a means for directing gas flow over the exterior of the elongated body to promote removal of small volumes of liquid from the tip.

In a preferred embodiment the pipette tip is disposable and may further comprise a relief valve positioned at the interface portion, a fluid analysis chamber and/or one or more collapsible reservoirs.

In another aspect of the present invention a pipetting device is provided comprising a housing having a pipette tip receiving end and a plurality of gas channels and at least one aperture for receiving gas; a plurality of valves, each of the valves connected to at least one of the gas channels controlling gas pressure in at least one gas channel; one or more supply channels from at least one gas receiving aperture for supplying gas to each of the valves; a means for controlling the valves; and at least one nozzle on the pipette tip receiving end for directing gas flow over the exterior of a pipette tip to promote removal of small volumes of liquid from the tip.

In one embodiment of this aspect of the invention the aperture for receiving gas is a gas cartridge chamber. In another embodiment of this aspect of the invention the device may be a pipettor manifold for automated equipment or a handheld pipettor.

When the device is a handheld pipettor it may comprise a housing having a pipette tip receiving adapter on one end and indicator panel and adjustment means on the other end, the indicator panel connected to the adjustment means; a means for aspirating and dispensing a fluid, the means able to interface with a pipette tip when fitted in the receiving adapter and connected to the adjustment means for regulating aspirating and dispensing; a power supply connected to the indicator panel, the adjustment means and the means for aspirating and dispensing; and a means for providing and directing gas flow over the exterior of the pipette tip to promote removal of small volumes of liquid from the tip.

In one preferred embodiment the means for aspirating and dispensing comprises a gas supply cartridge; a plurality of gas channels connected to the gas supply cartridge on one end and interfacing with the pipette tip on the other end; and a plurality of valves each of the valves controlling gas pressure from said gas supply cartridge to at least one gas channel.

In another aspect of the invention a method of dispensing and aspirating nano-volumes of liquid is provided comprising connecting a gas cartridge in the gas cartridge chamber; affixing the pipette tip to the pipette tip receiving end of the pipetting device; adjusting the means for controlling the valves to a desired nano-volume; and activating the means for controlling the valves to aspirate and or dispense the desired nano-volume.

### BRIEF DESCRIPTION OF THE DRAWINGS

FIG. 1 is an isometric view of one pipette tip of the present invention;

FIG. 2 is a cross-section view, with some detailed views, of the pipette tip in FIG. 1;

FIG. 3 is an isometric view of a pipettor, control module and pipette tip.

FIG. 4 is a cross sectional view of the interface between the pipettor in FIG. 3 and the pipette tip in FIG. 1.

FIG. 5 is a cross sectional view of another pipette tip of the present invention.

FIG. 6 is a cross sectional view of an interconnected pipette tips of the present invention.

FIG. 7 are cross sectional and isometric views of a normally closed reservoir or channel being inflated by the application of pressure.

### DETAILED DESCRIPTION

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “alignment means” as used herein refers in general to the element of the invention that provides orientation of the pipette tip in the pipettor to align the flexible membranes of the reservoirs with the means for aspirating and dispensing. For example, the alignment means is a guide such as a fin, a vane a taper or a pin that helps orient the tip in relation to the pipettor. IN another example the pipettor interface end of the pipettor tip may be designed to be asymmetric such that the tip may only be inserted into the pipettor in one orientation.

The term “means for directing gas flow” as used herein refers in general to the element of the invention that directs gas flow over the exterior surface of the pipette tip to assist in the removal of the fluid volume being dispensed. For example, the means for directing gas flow could be an annular array of a plurality of nozzles on the pipette interface of the pipettor that directs a laminar gas sheath flow along the outer or exterior surface of the tip.

The term “means for providing gas” as used herein refers in general to the element of the invention that provides gas pressure for the actuation of the reservoirs and for providing gas to the means for directing gas flow. For example the means for providing gas could be from a gas cartridge such as a CO₂ cartridge or from a remote gas pressure source connected by pressure lines to the device.

The term “means for providing and directing” as used herein refers in general to a combination of the means for providing and the means for directing gas as stated above.

The term “means for controlling” as used herein refers in general to the electronics of the device, also referred to as the control module, that provide among other things, a power supply, a visual readout of the function to be performed, an electronic volume adjustment, electronic valve activation to provide means for performing the desired function and programming that provides the commands to perform the desired functions.

The term “adjustment means” as used herein refers in general to a element of the invention that may be controlled by the user to adjust the volume of liquid to be aspirated, dispensed, manipulate or mixed. For example the adjustment means could be provided as a twist knob or key pad with up and down arrow buttons.

The term “means for aspirating and dispensing” as used herein refers in general a number of methods utilized to actuate the flexible membranes of the reservoirs. For example, pressure may be applied to the flexible membranes of the reservoirs by gas, fluid, such as oil or water, or by mechanical means such as a piston, electromagnetic plates positioned opposite each other on the exterior of a reservoir and the like.

The term “actuate”, “actuation” and “actuating” as used herein refer in general to applying a force, or acting on, the flexible membranes of the reservoirs. More specifically this could be the action of compression followed by release of the membrane or visa versa. The act of compression and release may be performed by a variety of means including for example, air pressure, pneumatic pressure, hydraulic pressure or by mechanical means such as a piston.

The present invention is directed to pipette tips and pipetting devices that use pipette tips for aspirating, mixing, manipulating and dispensing nano-volumes of fluid utilizing a directed gas flow along the exterior surface of the tip to assist in dispensing the liquid.

The Pipette Tip

The present invention provides a pipette tip for a pipetting device comprising an elongated body having a front portion, a pipettor interface portion, an upper surface and a lower surface; a plurality of reservoirs positioned at the interface portion, the reservoirs having a plurality of flexible membranes covering the reservoirs along the upper surface or the upper and lower surfaces; an fluidic channel through the elongated body connecting the plurality of reservoirs; an aligning means on the pipettor interface portion to position the tip in the pipetting device; and a means for directing gas flow over the exterior of the elongated body to promote removal of small volumes of liquid from the tip.

The pipette tip of the present invention may comprise a solid support containing one or more fluidic channels or reservoirs, or both. Reservoirs may be provided with rigid walls or flexible walls. When not in use the rigid wall reservoir provides a standing open volume to receive fluid while the flexible walled reservoir is collapsed when not filled with liquid. The fluidic channels and/or reservoirs can be sequentially depressed, or sealed, and released in such a way as to produce peristalsis within the cavities which causes a very small amount of liquid to be aspirated into the tip; dispensed from the tip; or transferred, mixed, or segregated within the tip. The depression or sealing, and release can be produced by pneumatic, hydraulic, or mechanical means. The pipette tip can also incorporate other features such as valves for controlling the movement of the liquid down certain internal paths, devices that perform measurements on the liquid while within the tip, and windows that allow external measurements to be made on the liquid within the tip.

The pipette tip can exist as a single unit or as multiple connected units to be used for multi-dispensing. In addition, certain cavities within the pipette tip can be constructed in such a way as to allow for transfer of fluids between multiple interconnected (multiplexed) tips.

The pipette tip is adapted for use with hand-held pipettors, pipetting instrument heads or other similar devices.

The pipette tip may be prepared by injection molding in one or more pieces that may be assembled to form the final product. Further the pipette tip may be made of the same material, as when it is prepared in a single piece, or may be prepared from one or more materials, if prepared in one or more pieces. For example, the body of the pipette tip may be made of a relatively rigid flexible plastic, or polymer, while the reservoir membranes may be made of an easily deformable or flexible plastic, or polymer, of the same or different material. If prepared in two or more pieces requiring assembly the pieces may be joined by adhesive or welding of the polymers. The type of material selected to construct the pipette tip will depend on its intended use. Preferably the pipette tip is made of a hydrophobic material particularly where the fluid being aspirated, dispensed, mixed or manipulated contacts the tip.

Multiple pipette tip constructions may be prepared as a single unit or may be prepared individually and later joined. For example, a pipette tip strip may be form molded containing a desired number of pipette tips joined together for use in a manifold for automated equipment. The number of pipette tips in a strip will depend on the number of operations being conducted by the automated system at a given time. For example, if the manifold is aspirating or dispensing into a microtiter plate the number of wells in a given column will determine the number of pipette tips in a strip (e.g. 2, 4, 8, 12, 16, etc.). Correspondingly, any number of pipette tips can be joined following production by adhesive or polymer welding. External surface configurations of the tips conducive to joining will be utilized for ease of manufacture and use.

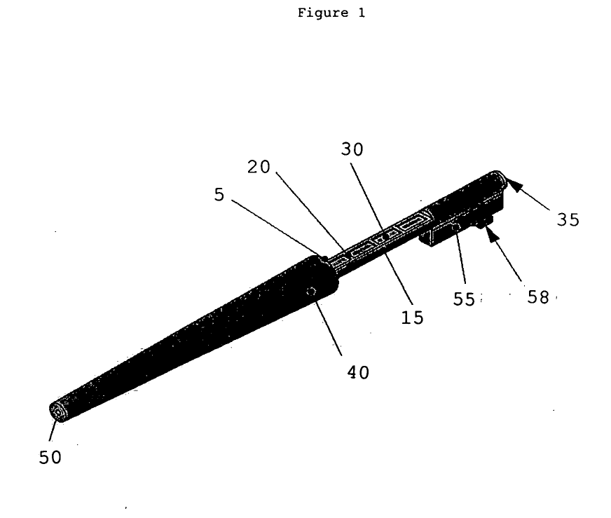

FIG.1 shows an isometric view of the pipette tip 5 in one preferred configuration according to the present invention. The pipettor interface portion of the pipette tip contains the pump 15 comprising a plurality of reservoirs separated by supporting struts 20 and covered by a plurality of flexible membranes 30. The pipette tip has an internal fluidic channel 50 of about 100-250 micrometers. The alignment means 55, preferably a fin, on the posterior of the pipettor interface portion is for locating the pipette tip properly in the pipettor. The pipette tip also has a terminal flexible membrane 35 at the end of the pipettor interface portion to translate any pressure differences that develop inside the tip. The outer surface of the pipette tip 40 is designed to promote laminar gas flow around the outside of the tip. A relief valve 58 may be a flap, a solenoid valve or any other mechanism that is normally closed and opens only when actuated.

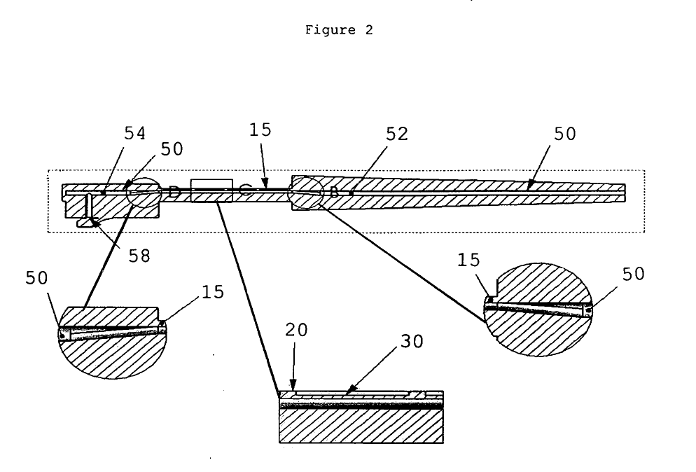

FIG. 2 shows a cross sectional view of the pipette tip 5. The fluidic channel 50 reduces in height as it approaches the pump 15 from the fluid interface portion, but the width of the fluidic channel increases maintaining the same volume. The relief valve 58 is normally closed. Relief valve 58 may is normally closed and only opens when actuated. The fluidic channel 52 below the pump 15 is the forward reservoir and the fluidic channel 54 above the pump is the rear reservoir. The supporting strut 20 and the flexible membrane 30 are also shown.

The pipette tip described above can be utilized with liquid handling systems such as a handheld pipettor or an automated pipettor system. In addition, it may be used as a liquid transfer or storage container, a mixing vessel, or any other application in which a pump or pumps and valves are required.

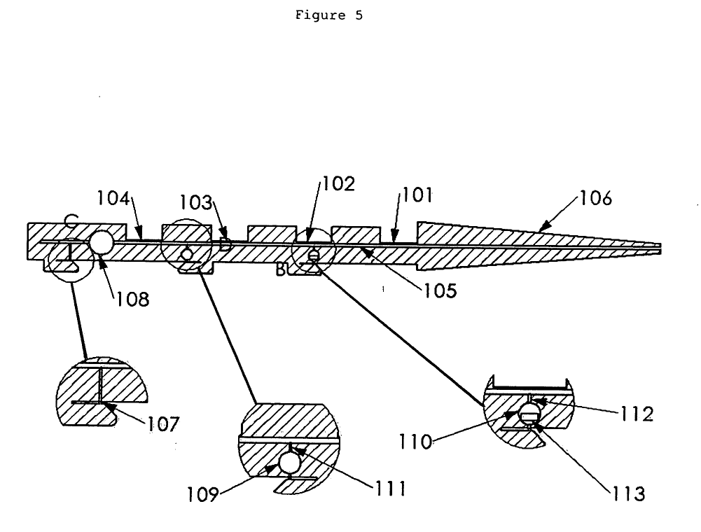

FIG. 5 is a cross sectional view of a pipette tip in another preferred configuration in accordance with the present invention. The solid matrix of the pipette tip is indicated by the hatched area. The remaining detail in the figure represents the inner structure of the tip. The pipette tip is shown with four flexible membranes covering the fluidic channel underneath at discrete locations 101, 102, 103, 104. These flexible membranes may be activated sequentially to create a peristaltic action within the pipette tip. The flexible membranes may be contiguous, with or without supports separating them or separated by a length of fluidic channel 105 not covered by a flexible membrane as depicted. The pipette tip has an elongated fluidic channel 106 at the fluid interface portion end to access external vessels for liquid transfer. The pipettor interface portion of the pipette tip contains a relief valve 107 and/or an additional reservoir 108. Other reservoirs are shown, 109 and 110 attached to either the restricted fluidic channel 111, 112 respectively or the fluidic channel underneath the flexible membrane 102 by fluidic channel 112, which may be smaller in diameter, provided with substantially greater hydrophobic surfaces, or contain a means to restrict flow. The reservoirs and channels not used for pumping may be collapsed when not in use or may be connected to relief valves. The reservoirs may further comprise special adaptations such as a viewing window 113 to allow measurements to be made from devices incorporated into the pipettor device, or from other external devices.

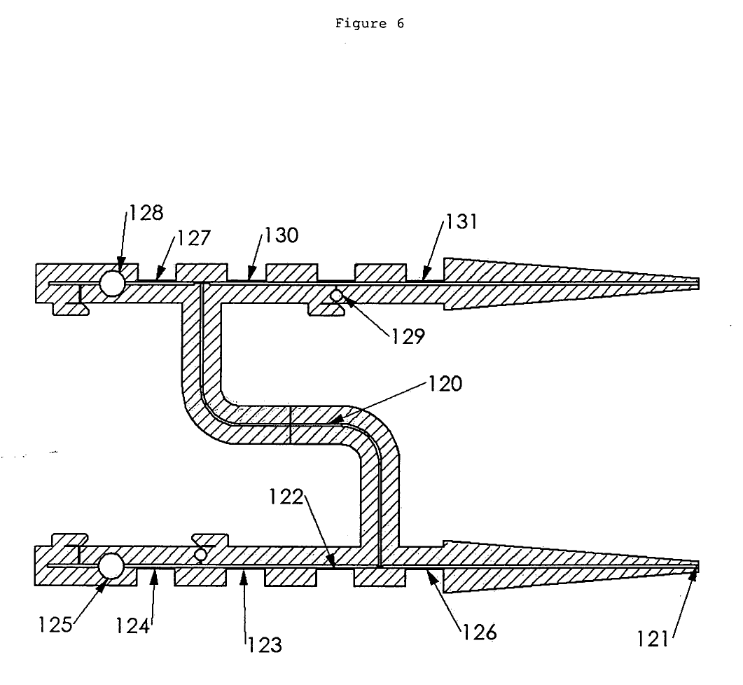

FIG. 6 is a cross sectional view of an array of pipette tips wherein each tip has a configuration similar to those described in FIG. 5. This figure shows two arrayed pipette tips that have been interconnected by a fluidic channel 120 to allow fluid flow between them. The array may contain a plurality of pipette tips (e.g. 8 or 12). These tips may also be individual inter-connectable tips rather than part of a multi-tip array.

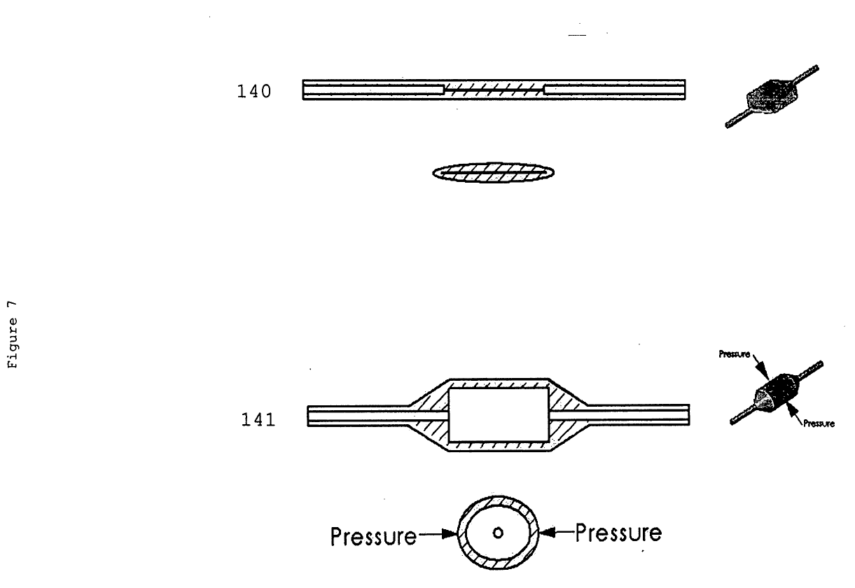

FIG. 7 is a cross sectional and isometric views of a normally collapsed, reservoir or fluidic channel in the fluid pathway in both its collapsed 140 and expanded 141 states. These could be any of the in-line and separate reservoirs in FIG. 6, depending upon the flexibility of the material used.

The Pipettor Device

The pipetting device according to the present invention comprises a housing having a pipette tip receiving end and a plurality of gas channels and a gas cartridge chamber; a plurality of valves each of the valves connected to at least one of the gas channels controlling gas pressure in at least one gas channel; a one or more supply channels from the cartridge chamber for supplying gas to each of the valves; a means for controlling the valves; and at least one nozzle on the pipette tip receiving end for directing gas flow over the exterior of a pipette tip to promote removal of small volumes of liquid from the tip.

The device of the present invention may be constructed using similar materials and electronic components as currently available commercial devices.

In one preferred configuration the pipetting device is a handheld pipettor utilizing a pipette tip wherein the means for aspirating and dispensing comprises a gas supply cartridge; a plurality of gas channels connected to the gas supply cartridge on one end and interfacing with the pipette tip on the other end; and a plurality of valves each of the valves controlling gas pressure from the gas supply cartridge to at least one gas channel.

In a particularly preferred embodiment the handheld pipettor comprises a housing having a pipette tip receiving adapter on one end and an indicator panel and adjustment means on the other end, the indicator panel connected to the adjustment means; a means for aspirating and dispensing a fluid, the means able to interface with a pipette tip when fitted in the receiving adapter and connected to the adjustment means for regulating aspirating and dispensing; a power supply connected to the indicator panel, the adjustment means and the means for aspirating and dispensing; and a means for providing and directing gas flow over the exterior of the pipette tip to promote removal of small volumes of liquid from the tip.

One aspect of the present invention comprises a pipettor device that applies discrete pneumatic, hydraulic, or mechanical pressure through a series of channels to a tip or a plurality of tips. The pressure can be punctuate or continuous, and can be applied through any or all of the individual channels in any order. The device may further comprise an gas curtain for removing drops from the pipette tip and directing them to their target, a pressure sensor capable of detecting small changes in pressure indicating the movement of small amounts of liquid into, or out of the pipette tip, and/or a pointing device (e.g. laser pointer) to guide the user in the movement of small amounts of liquid to, or from precise targets (e.g. microtiter plate wells). The invention can be used in hand-held pipettors, pipetting instrument heads, drug deliver pumps, or other similar devices.

Another aspect of the present invention is a non-piston driven active pipette tip that can aspirate and dispense nanoliter volumes accurately and repetitively. It uses a peristaltic type actuating motion to aspirate nanoliter volumes and the same system plus the addition of sheath gas flow over the exterior of the pipette tip surface to assist in dispensing these volumes.

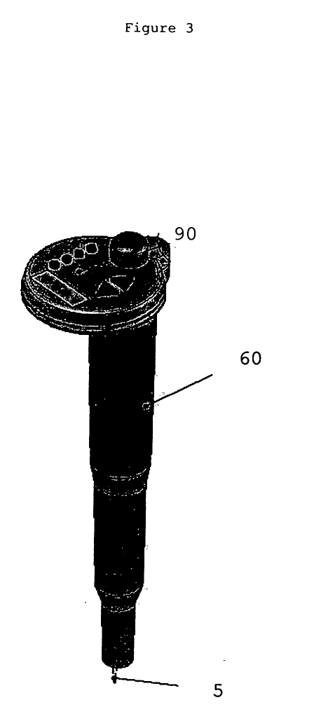

FIG. 3 shows the pipettor 60, control module 90 and pipette tip 5 mounted together as they would be during use.

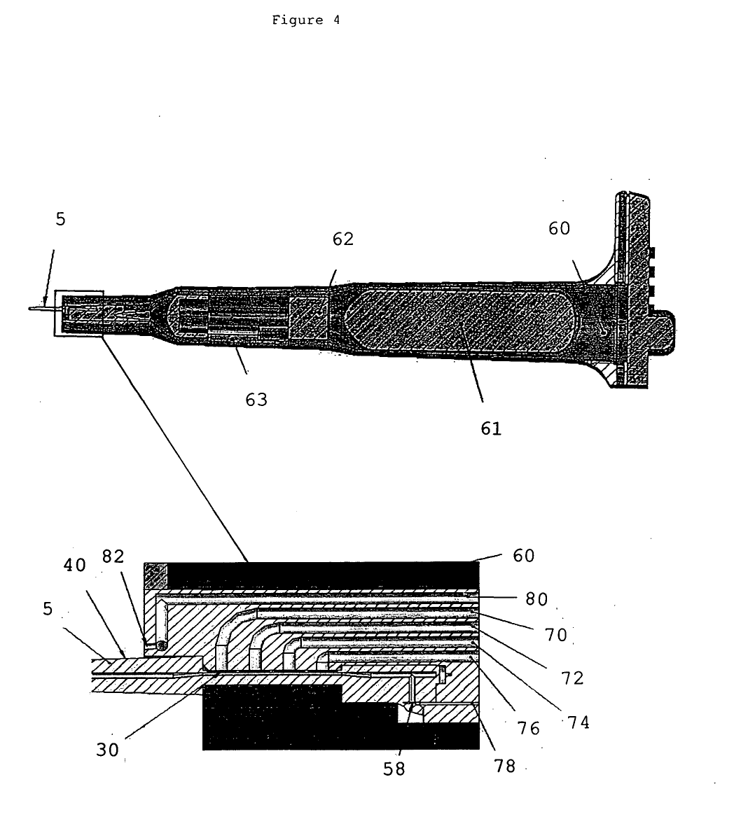

FIG. 4 shows a cross sectional view of pipettor 60 showing the pipette tip 5, the valves 63, the cartridge 61, the docking port 62 and the interface between the pipettor 60 and the pipette tip 5. There are a plurality of gas channels that may be provided in the pipettor device manifold. In this configuration the pipettor has six channels that interact with the flexible membranes within the pipette tip. Valves in the pipettor actuate the gas channels. Gas channels 70,72,74,76 fit over sections of the flexible membrane on the pipette tip 30. Gas channel 78 actuates the normally closed relief valve 58. Gas channel 80 supplies gas to the annular array of a plurality of nozzles 82 creating an annular and laminar gas sheath flow along the outer surface of the pipette tip 40 that assists in releasing dispensed fluid from the pipette tip via the Bernoulli effect. This aids in non-contact aspiration, and ensures no capillary retention of liquid if the tip is immersed into receiving liquid. The cartridge is docketed at a docking port 62 that engages the gas cartridge 61 allowing gas to flow through one or more valves 63 to gas channel 80 to the nozzles 82 when activated by the control module.

Operation

A method of dispensing and aspirating nano-volumes of liquid using the pipette tip and the pipettor device of the present invention is provided comprising connecting a gas cartridge in the gas cartridge chamber; affixing the pipette tip to the pipette tip receiving end of the pipetting device; adjusting the means for controlling the valves to a desired nano-volume; and activating the means for controlling the valves to aspirate and or dispense the desired nano-volume.

In use, the operator inputs one or more commands into a program through a control module within the device. Once actuated the program performs the commands applying discrete pressure through gas channels in the device that interface with flexible membranes positioned along the fluidic channel of the pipette tip in a particular order. For example, a series of flexible membranes along the fluidic channel may be activated and deactivated sequentially to produce peristaltic pumping action in the pipette tip.

When dispensing a nano-volume of liquid during use, an air or gas curtain is applied down and along the pipette tip assisting in releasing the volume from the tip.

The device may further comprise a laser pointer directed down the pipette tip to assist the operator in aiming the tip so that the liquid can be delivered to the desired location. The laser pointer may also be used to guide the pipette tip into a vessel for fluid aspiration.

In addition the device may further comprise a pressure sensor that may respond to small changes in pressure caused by the compression of a flexible membrane in the pipette tip in response to the pressure applied by the device during dispensing or aspirating. For example, a small change in pressure caused by compression of a flexible membrane when fluid is dispensed can be interpreted by the control module, using known data, to indicate to the operator that a volume of liquid has been delivered.

In operation for aspirating and dispensing nano-volumes of liquid the tip 5 would be inserted into the pipettor 60. The fin 55 would align the pipette tip 5 in the pipettor 60 such that the pump 15 and the relief valve 58 in the tip with the gas channels in the pipettor 70,72,74,76,78. The alignment means is a guide and may be, for example, a fin, a vane, a taper, or a pin that helps orient the tip in relation to the pipettor or similar device to which the tip may be attached. When any of the gas channels are actuated (turned on) gas pressure (i.e. greater than atmospheric pressure, preferably greater than 100 psi) will build in those channels, forcing the flexible membrane to expand and block the fluidic channel 50 in the pipette tip 5. Actuating the gas channels in a specific sequence or set of sequences can produce a positive pressure force or a negative pressure force in the forward reservoir 52 of the pipette tip. An opposite force will be created in the back reservoir 54 which can be neutralized by opening the normally closed relieve valve 58. The positive and negative pressures in the forward reservoir 52 can be used to aspirate and dispense liquids in a multiplicity of modes in stepwise or continuous sequence, for example an aspiration followed by repeat dispensing, multiple aspiration to mix fluids, serial aspiration of diluent and solute to effect dilution, or an aspiration to retain and store fluid in the pipette tip.

The pipettor may further supply gas emitted from the pipettor and tip interface that will flow over the outer, or exterior, surface 40 of the pipette tip 5. The flow will be such that it would create a negative pressure at the front of the tip. This negative pressure will counteract any forces between the liquid and the tip separating the liquid from the tip, aid in non-contact dispensing, and obviate liquid retention on the pipette tip upon withdrawal from a fluid if the tip is immersed during transfer. The gas flow rate and flux will be sufficient to ensure dispense without blowout of sample into a dry receptacle. This sheath will also serve to “wipe” the exterior surface of the pipette tip of any excess source liquid immediately after an initial filling operation.

In a particularly preferred embodiment, the source of gas will be from pre-filled cartridges 61 that can be filled with any number of gases dry or humidified depending upon the desired application. These cartridges maybe incorporated into the pipettor or may be separate. The cartridge is docketed at a docking port 62 that engages the gas cartridge 61 allowing gas to flow through one or more valves 63 to gas channel 80 to the nozzles 82 when activated by the control module. For example during transfer of a stock solution of compound in dimethylsulfoxide (DMSO), a DMSO saturated inert gas such as argon or nitrogen can be utilized to minimize chemical reactivity, water absorption, and evaporation during transfer, and leave the sample under a inert gas blanket. In transfer and handling of infectious agents chemical sterilant gases such as ethylene oxide may be used.

In operation for dispensing and aspirating in conjunction with manipulating and mixing the flexible membranes covering lengths of the fluidic channels 101, 102, 103, 104 are sequentially compressed and released in a cyclic manner. For a single membrane the compression areas (or sections) of the membrane are sequentially compressed and released. Compression decreases the volume of the underlying fluidic channel, while release restores the volume by allowing the membrane, and thereby the fluidic channel, to assume their original shapes. Compression can be produced by applying pressure to the flexible membranes, and release can be produced by removing the pressure. Pressure can be produced by pneumatic, hydraulic, or mechanical means. If the membranes are compressed and released (hereafter called “activated”, and the process called “activation”) in the proper sequence (e.g. 101 compressed, then 102 compressed, then 101 released, then 103 compressed, then 102 released, etc.), peristaltic pumping is produced resulting in fluid flow through the reservoirs, and the fluidic channels attached to them.

The fluidic channels or reservoirs can also be normally closed or collapsed 140 and opened when actuated. In this case the entire fluidic channel is comprised of a flexible membrane with more rigid ribs through its center or a semi-flexible membrane. When force is applied parallel to the surface they will deflect, perpendicular to the surface and away from each other. This will open the reservoir or fluidic channel. When activated in this manner, the fluidic channel or reservoir opens 141 and creates a vacuum that will be filled by fluid in the pipette tip. Another way to expand the fluidic channel or reservoir is by applying positive pressure from inside and filling it. When the pressure is released the fluidic channel reverts to its normally closed position. This type of fluidic channel or reservoir can be substituted throughout for the normally opened reservoirs or fluidic channels.

In use fluid can be aspirated into the pipette tip if the membranes are activated in proper sequence and combinations (i.e. the order of compression is 101, 102, 103, etc.) and if in reverse order, fluid can be dispensed from the tip. Specifically, if all four of the membranes are activated in order, fluid is transferred into reservoir 108. Activation in reverse order causes fluid to be dispensed from the same reservoir.

As another example, if only three of the membranes are activated, and the fourth is sealed, fluid can be aspirated from, or transferred into, one of the other reservoirs 109, 110. Sealing is achieved by applying sufficient pressure to the membrane to cause it to contact or nearly contact the other walls of the reservoir, thereby severely restricting or preventing fluid passage. Specifically, if the first three 101, 102, 103 are activated in order and the fourth 104 is sealed, fluid can be aspirated into a particular reservoir 109.

Further, if the final three flexible membranes 102, 103, 104 are activated in reverse order and the first 101 is sealed, fluid previously aspirated into one reservoir 108 can be moved to a different reservoir 110.

If the reservoirs receiving or providing fluid are normally open, air exchange to allow fluid movement can be achieved using a relief valve 107. If the reservoirs are normally closed 140 (e.g. collapsed) then fluid will be able to enter, or exit, the space by inflating 141 or deflating the reservoir without need for a pressure relief mechanism.

The fluidic channels with restricted flow connected to some of the reservoirs 111, 112 are fluidic channels that oppose the passage of liquid during normal aspirating or dispensing. This opposition can be achieved by flexible membrane valves actuated by the pipettor, by pressure-induced constriction, by constructing them in a normally closed state so that higher pressure is needed to pass liquid through them than through the main fluidic channels, by making them sufficiently small compared to the main fluidic channels that liquid preferentially flows through the main channels, or by chemically modifying their inner surfaces (e.g. making them hydrophobic) so that liquids prefer the main fluidic channels.

By briskly moving liquid from one reservoir to another within the pipette tip, mixing may be produced. By moving liquid into a reservoir that allows measurement, the pipette tip can serve as a measurement device, or as a vessel for an external measurement device. By taking up liquid into the pipette tip and then sealing the end of the tip (e.g. with an inert gel) the tip can serve as a storage device. Subsequent release of the stored fluid can be produced, for example, by first dispensing a fluid that releases the seal, and which had been placed in a different reservoir than the stored fluid, and then dispensing the stored fluid or by leaving an air gap between the stored fluid and the gel and then just pushing the gel and the air out of the pipette tip.

To operate pipette tips that are interconnected by a fluidic channel or reservoir 120, liquid can first be aspirated through the external access fluidic channel of one of the pipette tips 121 into one of the reservoirs in the tip. For example, by sequentially activating the flexible membranes of one pipette tip in linear order (e.g. 126, 122, 123, 124) fluid can be aspirated into a particular reservoir 125 in that tip. Then by activating three of the flexible membranes in reverse order (e.g. 124, 123,122) while sealing the fourth 126, liquid can be pumped through the fluidic channel 120 to the other pipette tip. By selectively blocking reservoirs or channels in the receiving pipette tip, the fluid can be directed to a desired reservoir. For example, by activating flexible membrane of reservoir 130 the fluid can be moved into another reservoir 128. Alternatively, by blocking two other flexible membranes of reservoirs 127 and 131 the fluid can be delivered into a different reservoir 129.

1. A pipette tip for a pipetting device comprising:
an elongated body having a front portion, a pipettor interface portion an upper surface and a lower surface;
a plurality of reservoirs positioned at the interface portion, said reservoirs having a plurality of flexible membranes covering the reservoirs along the upper surface or the upper surface and lower surface;
a fluidic channel through said elongated body connecting said plurality of reservoirs;
an aligning means on said pipettor interface portion to position said tip in said pipetting device; and
a means for directing gas flow over the exterior of said elongated body to promote removal of small volumes of liquid from said tip.

2. A pipette tip according to claim 1 further comprising a relief valve positioned at the interface portion.

3. A pipette tip according to claim 1 wherein said tip is disposable.

4. A pipette tip according to claim 1 further comprising a fluid analysis chamber.

5. A pipette tip according to claim 1 wherein said reservoirs are collapsible.

6. A pipetting device comprising:
a housing having a pipette tip receiving end and a plurality of gas channels and a means for providing gas, said plurality of gas channels;
a plurality of valves each of said valves connected to at least one of said gas channels controlling gas pressure in at least one gas channel; at least one or more supply channels from said means for providing gas for supplying gas to each of said valves;
a means for controlling said valves; and
at least one nozzle on said pipette tip receiving end for directing gas flow over the exterior of a pipette tip to promote removal of small volumes of liquid from said tip.

7. A pipetting device according to claim 6 wherein the device is a pipettor manifold for automated equipment.

8. A pipetting device according to claim 6 wherein the device is a handheld pipettor.

9. A method of dispensing and aspirating nano-volumes of liquid using the pipette tip according to claim 1 and the pipettor device according to claim 6 comprising:
connecting a gas cartridge in said gas cartridge chamber;
affixing said pipette tip according to claim 1 to the pipette tip receiving end of said pipetting device according to claim 6;
adjusting said means for controlling said valves to a desired nano-volume; and
activating said means for controlling said valves to aspirate and or dispense said desired nano-volume.

10. A handheld pipettor comprising:
a housing having a pipette tip receiving adapter on one end and indicator panel and adjustment means on the other end, said indicator panel connected to said adjustment means;
a means for aspirating and dispensing a fluid said means able to interface with a pipette tip when fitted in said receiving adapter and connected to said adjustment means for regulating aspirating and dispensing;
a power supply connected to said adjustment means and said means for aspirating and dispensing; and
a means for providing and directing gas flow over the exterior of said pipette tip to promote removal of small volumes of liquid from said tip.

11. A handheld pipettor according to claim 9 utilizing a pipette tip according to claim 1 wherein said means for aspirating and dispensing comprises:
a gas supply cartridge;
a plurality of gas channels connected to said gas supply cartridge on one end and interfacing with said pipette tip according to claim 1 on the other end; and
a plurality of valves each of said valves controlling gas pressure from said gas supply cartridge to at least one gas channel.
